(19) United States
(12) Patent Application Publication
(10) Pub. No.: US 2026/0216912 A1
(43) Pub. Date: Jul. 30, 2026

(54) ACETYLATED WOOD

(71) Applicant: YKK AP Inc., Chiyoda-ku (JP)

(72) Inventors: Masaki Wakabayashi, Tokyo (JP); Masahiro Yoshino, Tokyo (JP)

(21) Appl. No.: 19/408,420

(22) Filed: Dec. 4, 2025

(30) Foreign Application Priority Data
Jan. 29, 2025 (JP) 2025-013124

(51) Int. Cl. B27K 3/02; B27K 3/08

(52) U.S. Cl. CPC B27K 3/0207; B27K 3/08

(57) ABSTRACT

An acetylated wood includes a surface-side portion that includes a wood surface and is acetylated, and an inner portion located inside the surface-side portion. A peak height ratio A/B of a peak height A at 1740 cm⁻¹ to a peak height B at 1510 cm⁻¹ in an infrared absorption spectrum of the surface-side portion is 2 or more. A peak height ratio C/D of a peak height C at 1740 cm⁻¹ to a peak height D at 1510 cm⁻¹ in an infrared absorption spectrum of the inner portion is 0.5 or less.

### CROSS-REFERENCE TO RELATED APPLICATION(S

The present application claims priority to and incorporates by reference the entire contents of Japanese Patent Application No. 2025-013124 filed in Japan on January 29, 2025.

### BACKGROUND

### 1. Technical Field

The present disclosure relates to an acetylated wood having durability ensured by acetylation.

### 2. Related Art

In a case where wood is used for a building material installed outdoors, high durability is required for the wood to withstand long-term use outdoors. In contrast, by acetylating the wood, durability of the wood is improved. The acetylated wood is imparted with, for example, weather resistance, durability against decay caused by decay fungi and damage caused by termites and the like, and durability against dimensional change (dimensional stability). Regarding acetylated wood, conventionally, a method for modifying a wooden material by acetylating a hydroxyl group in a wood component is known (see JP H7-20605 B).

In the conventional method of modifying a wooden material described in JP H7-20605 B, after impregnating the wooden material with an acetylation reaction solution containing acetic anhydride and an acetate, the wooden material is acetylated by heating treatment. In addition, the acetylation reaction solution is uniformly impregnated into the wooden material by using a reduced-pressure method or a reduced-pressure pressurization method. However, in the conventional method for modifying a wooden material, the amount of the acetylation reaction solution used tends to increase as the entire wooden material is uniformly impregnated with the acetylation reaction solution, and there is also a concern that the time required for impregnating the wooden material with the acetylation reaction solution becomes long. Therefore, the manufacturing cost of the acetylated wooden material may increase.

### SUMMARY

The disclosure has been made in view of the above conventional problems, and it is desirable to provide an acetylated wood capable of reducing manufacturing cost while ensuring durability.

In some embodiments, an acetylated wood includes: a surface-side portion that includes a wood surface and is acetylated; and an inner portion located inside the surface-side portion. A peak height ratio A/B of a peak height A at 1740 cm⁻¹ to a peak height B at 1510 cm⁻¹ in an infrared absorption spectrum of the surface-side portion is 2 or more, and a peak height ratio C/D of a peak height C at 1740 cm⁻¹ to a peak height D at 1510 cm⁻¹ in an infrared absorption spectrum of the inner portion is 0.5 or less.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a perspective view illustrating a deck in which acetylated wood of the present embodiment is used as a building material;

FIG. 2 is a flowchart illustrating a manufacturing procedure of an acetylated wood of the present embodiment;

FIG. 3A is a cross-sectional view illustrating wood before acetylation of the present embodiment and FIG. 3B is a cross-sectional view illustrating wood after acetylation of the present embodiment;

FIG. 4 is a graph illustrating an example of an infrared absorption spectrum of acetylated wood of the present embodiment;

FIGS. 5A and 5B are cross-sectional views illustrating other examples of acetylated wood of the present embodiment;

FIG. 6 is a cross-sectional view illustrating acetylated wood of examples;

FIG. 7 is a graph illustrating an infrared absorption spectrum of acetylated wood;

FIG. 8 is a graph illustrating an infrared absorption spectrum of acetylated wood; and

FIG. 9 is a graph illustrating an infrared absorption spectrum of acetylated wood.

### DETAILED DESCRIPTION

An embodiment of the acetylated wood will be described with reference to the drawings.

The acetylated wood of the present embodiment is a wood that has been subjected to acetylation treatment. In addition, the entire acetylated wood is not uniformly acetylated, and the degree of acetylation on the surface side of the acetylated wood is increased.

The acetylated wood is used, for example, as a building material. The building material is a material for construction, and the acetylated wood and the building material are used in outdoor structures requiring durability (for example, decks and fences). A building material made of acetylated wood is installed outside a building and is exposed to an outdoor environment.

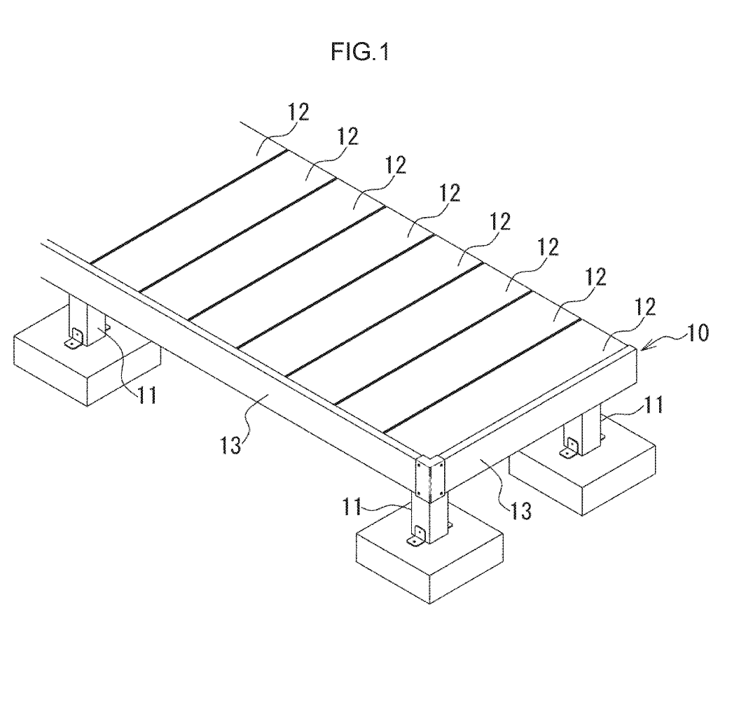

FIG. 1 is a perspective view illustrating a deck 10 using acetylated wood of the present embodiment as a building material, and illustrates a part of the deck 10 as viewed obliquely from above.

As illustrated in the drawing, the deck 10 is an outdoor structure, is attached to a building (not illustrated), and is installed outdoors. In addition, the deck 10 includes a plurality of foundation posts 11, a plurality of girders (not illustrated) bridged over the foundation posts 11, a plurality of joists (not illustrated) bridged over the girders, a plurality of floorboards 12 laid over the plurality of joists, and a fascia board 13 provided around the plurality of floorboards 12.

The plurality of floorboards 12 are plate-shaped deck members (plate members), and are provided on a floor surface of the deck 10. The plurality of floorboards 12 are disposed in parallel to each other to form a floor surface of the deck 10. Each of the foundation posts 11, the floorboard 12, and the fascia board 13 is a building material used for the deck 10, and constitutes a part of the deck 10. The deck 10 is a wood deck made of wood, and at least one of the foundation post 11, the floorboard 12, or the fascia board 13 is made of acetylated wood.

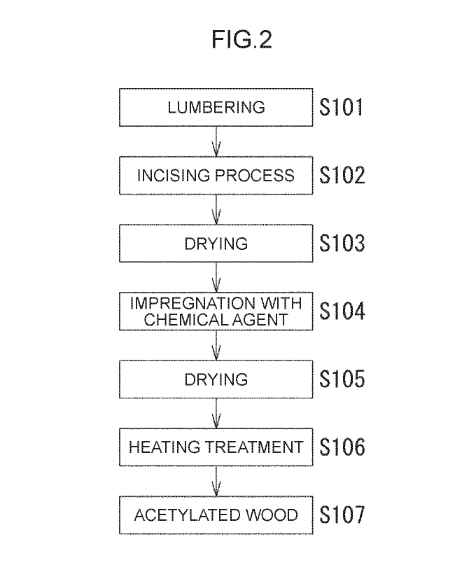

FIG. 2 is a flowchart illustrating a manufacturing procedure of an acetylated wood of the present embodiment.

As illustrated in the drawing, a lumbering apparatus processes wood (raw wood) serving as a raw material for acetylated wood by lumbering (S101 in FIG. 2). Subsequently, an incising apparatus performs an incising process on the processed wood (S102 in FIG. 2). The incising process is a process of forming cuts (here, holes) in wood, and examples thereof include a hole process by various lasers, a hole process by a blade, and a hole process by a drill. The laser is, for example, an ultraviolet laser (UV laser) or a carbon dioxide laser (CO₂ laser).

By the incising process (for example, hole process by a laser), the hole process is performed on the wood, thereby, a plurality of holes are formed in the wood. The holes formed in the wood are through holes penetrating the wood, or blind holes that do not penetrate the wood and are closed inside the wood. The plurality of holes are incising holes formed by the incising process, and are formed to be spaced from each other and dispersed in the wood and on the surface of the wood. The plurality of holes are opened on the surface of the wood and are opened toward the outside of the wood.

A drying apparatus heats the wood to a drying temperature to dry the wood (S103 in FIG. 2). Thereby, the wood is dried until the water content becomes 3% by mass (wt%) or less, so the water content of the wood is 3 wt% or less. The water content of the wood is measured based on the method for measuring the water content of wood specified in Japanese Industrial Standard (JIS Z2101:2009). Subsequently, by impregnation processing using an impregnation apparatus, a chemical agent for acetylation treatment is impregnated into the wood (S104 in FIG. 2), the wood is subjected to acetylation treatment, and an acetylated wood is manufactured.

A chemical agent is a liquid or gas chemical (modifier) used for acetylating wood, contains acetic anhydride, and penetrates into wood. The acetylated wood is manufactured by subjecting the wood to the acetylation treatment including impregnation with a chemical agent. The acetylation treatment is a chemical treatment (modifying treatment) for chemically modifying (improving) wood, and a chemical agent is used to modify wood. In addition, the acetylation treatment is a modifying treatment (durable treatment) for modifying durability of wood, and the acetylated wood is durable modified wood (modified wood). The durability of wood is, for example, decay resistance, weather resistance, ant resistance, strength, and dimensional stability.

In the acetylation treatment, acetic anhydride impregnated into wood causes an acetylating reaction in the wood to acetylate the wood. At that time, acetic anhydride and the wood component chemically react with each other, so that a hydroxyl group contained in the wood component is replaced with an acetyl group to produce acetylated wood. Water repellency is imparted to the acetylated wood. As a result, water absorption of the acetylated wood is suppressed, and durability of the acetylated wood is ensured.

When the wood is subjected to acetylation treatment, the entire wood is immersed in a chemical agent, and the chemical agent is allowed to permeate into the wood. The plurality of holes formed by the incising process are penetration holes for promoting penetration of the chemical agent into the wood. The wood and the plurality of holes are exposed to the chemical agent and come into contact with the chemical agent. The chemical agent penetrates from the surface of the wood and from the plurality of holes toward the inside of the wood, and is impregnated into the wood. Here, by impregnation processing at increased pressure or at normal pressure, the chemical agent is impregnated into the wood.

After impregnation with the chemical agent, the drying apparatus heats the wood to a drying temperature to dry the wood (S105 in FIG. 2). Subsequently, the heating apparatus heats the wood to a heating treatment temperature to subject the wood to a heating treatment (S106 in FIG. 2). The drying of the wood impregnated with the chemical agent and the heating treatment of the wood may be performed simultaneously. By the heating treatment, the acetylation reaction between the chemical agent and the wood is caused to proceed inside the wood, and acetylated wood is manufactured (S107 in FIG. 2).

When the wood is subjected to acetylation treatment, the chemical agent is not uniformly impregnated into the entire wood, and impregnation of the chemical agent into the wood is terminated when impregnation of the chemical agent into a surface-side portion including the surface of the wood has been completed. Thereby, the chemical agent is not impregnated into the entire wood, but is impregnated only into a surface-side portion of the wood. The chemical agent is not impregnated into a part of the inside of the wood, and a portion into which the chemical agent has not been impregnated is left inside the wood. Alternatively, the impregnation amount of the chemical agent is made larger in a surface-side portion of the wood than in an inner portion of the wood, and the impregnation amount of the chemical agent is made different between the surface-side portion and the inner portion of the wood.

In a case where the chemical agent is impregnated only into a surface-side portion of the wood, only the surface-side portion of the wood is subjected to acetylation treatment, and only the surface-side portion of the wood is acetylated. In contrast, a part of the inside of the wood is not subjected to acetylation treatment, and a part of the inside of the wood is not acetylated. Therefore, the acetylated wood is partially acetylated, and includes a portion acetylated by the acetylation treatment (acetylated portion) and a portion not acetylated (non-acetylated portion). Furthermore, the acetylation treatment is applied to a part of the acetylated wood including the surface of the acetylated wood, and a part of the acetylated wood including the surface of the acetylated wood is acetylated.

In a case where the impregnation amount of the chemical agent is made larger in a surface-side portion of the wood than in an inner portion of the wood, mainly, the acetylation treatment is applied to the surface-side portion of the wood, and acetylation proceeds in the surface-side portion of the wood. In contrast, in an inner portion of the wood, the acetylation treatment is not sufficiently applied, and the acetylation does not sufficiently proceed. Therefore, the degree of acetylation becomes higher in a surface-side portion of the acetylated wood than in an inner portion of the acetylated wood.

In a case where the entire wood is uniformly acetylated, the weight of the acetylated wood increases by about 25% relative to the weight of the wood before impregnation with the chemical agent. In contrast, here the weight of the acetylated wood is increased by a weight in the range from equal to or more than 2% to equal to or less than 20% relative to the weight of wood before impregnation of the chemical agent. Therefore, a weight increase ratio M of the acetylated wood is 2% or more and 20% or less. The weight increase ratio M is a value expressed as a percentage of a ratio of a difference between a weight W2 of the acetylated wood and a weight W1 of the wood before impregnation with the chemical agent relative to the weight W1, and is calculated by the formula (M=((W2−W1)/W1)×100). It is more preferable that the weight increase ratio M be 5% or more and 15% or less.

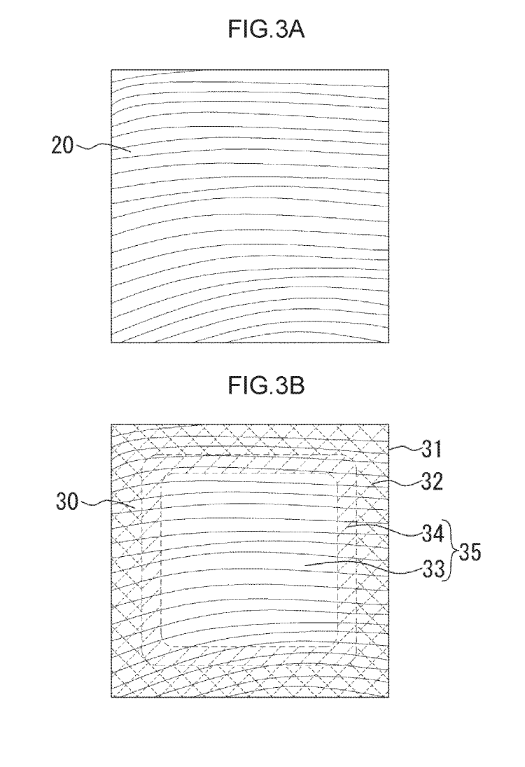

FIGA. 3A and 3B are cross-sectional views illustrating wood before and after acetylation of the present embodiment. FIG. 3A illustrates wood 20 before acetylation. FIG. 3B schematically illustrates the configuration of acetylated wood 30, which is wood after acetylation.

As illustrated, the acetylated wood 30 includes a wood surface 31, a surface-side portion 32 including the wood surface 31 (a portion provided with lattice hatching by a chain line in FIG. 3B), an inner portion 33 located on a central side of the acetylated wood 30 (a portion not provided with hatching in FIG. 3B), and an intermediate portion 34 located between the surface-side portion 32 and the inner portion 33 (a portion provided with oblique hatching by a chain line in FIG. 3B). Here, the acetylated wood 30 is a square timber and is formed in a square cross-sectional shape.

The wood surface 31, the surface-side portion 32, and the intermediate portion 34 are acetylated portions that have been acetylated. The inner portion 33 is a non-acetylated portion that is not acetylated, a portion including a non-acetylated portion and an acetylated portion whose degree of acetylation is lower than the degree of acetylation of the surface-side portion 32 and the degree of acetylation of the intermediate portion 34, or an acetylated portion whose degree of acetylation is lower than the degree of acetylation of the surface-side portion 32 and the degree of acetylation of the intermediate portion 34. The non-acetylated portion is an untreated portion to which the acetylation treatment has not been applied.

The wood surface 31 is a surface of the acetylated wood 30 and is exposed to the outside in the acetylated wood 30. The surface-side portion 32 is a surface-side acetylated portion located on the wood surface 31 side of the acetylated wood 30 and is provided only on the wood surface 31 side of the acetylated wood 30. The surface-side portion 32 is formed along the wood surface 31 without reaching a central portion (wood central portion) of the acetylated wood 30 from the wood surface 31.

The inner portion 33 and the intermediate portion 34 are an included portion 35 included in the acetylated wood 30 and are located inside the surface-side portion 32. The included portion 35 includes the intermediate portion 34, the inner portion 33, and a central portion of the acetylated wood 30, and is located on a central side (inner side) of the acetylated wood 30 relative to the surface-side portion 32. The inner portion 33 is located inside the intermediate portion 34.

The inner portion 33 is located inside the surface-side portion 32 with the intermediate portion 34 interposed between the inner portion 33 and the surface-side portion 32, and is covered by the intermediate portion 34 and the surface-side portion 32. Further, the inner portion 33 is a central-side portion including a central portion of the acetylated wood 30, and is located on a central side of the acetylated wood 30 relative to the surface-side portion 32 and the intermediate portion 34. The inner portion 33 is provided only on a central side (inner side) of the acetylated wood 30.

The intermediate portion 34 is an intermediate acetylated portion located between the surface-side portion 32 and the inner portion 33 of the acetylated wood 30. The intermediate portion 34 is located on a central side (inner portion 33 side) of the acetylated wood 30 relative to the surface-side portion 32 and is covered by the surface-side portion 32. Furthermore, the intermediate portion 34 is located on the wood surface 31 side (surface-side portion 32 side) of the acetylated wood 30 relative to the inner portion 33 and covers the inner portion 33. The intermediate portion 34 does not reach a central portion of the acetylated wood 30 from the surface-side portion 32, and is interposed between the surface-side portion 32 and the inner portion 33.

The acetylated wood 30 is subjected to the incising process. Therefore, the acetylated wood 30 has a plurality of holes (not illustrated) being opened on the wood surface 31. The plurality of holes are incising holes formed in the wood 20 before acetylation by the incising process. The plurality of holes are formed dispersed in the acetylated wood 30 and are opened dispersed on the wood surface 31. Here, the incising process is applied only to the surface-side portion 32 of the acetylated wood 30, and is not applied to the intermediate portion 34, the inner portion 33, and the included portion 35. Furthermore, the plurality of holes are blind holes and are not provided in the intermediate portion 34, the inner portion 33, and the included portion 35, but are provided only in the surface-side portion 32.

The surface-side portion 32, the inner portion 33, and the intermediate portion 34 of the acetylated wood 30 are identified based on respective infrared absorption spectra. The infrared absorption spectra of the surface-side portion 32, the inner portion 33, and the intermediate portion 34 of the acetylated wood 30 are measured by Fourier transform infrared spectroscopy (FT-IR) and are represented as graphs with the wavenumber (cm⁻¹) as the horizontal axis and the absorbance (abs) as the vertical axis. Furthermore, the infrared absorption spectrum is measured by an attenuated total reflection method (ATR method) using a Fourier transform infrared spectrophotometer conforming to the Japanese Industrial Standard (JIS K0117:2017).

The peak height at 1740 cm⁻¹and the peak height at 1510 cm⁻¹in the infrared absorption spectrum are measured to calculate a peak height ratio between the peak height at 1740 cm⁻¹ and the peak height at 1510 cm⁻¹. 1740 cm⁻¹ and 1510 cm⁻¹ are wavenumbers of the infrared absorption spectrum, and the peak height is a height of a peak of absorbance of the infrared absorption spectrum. In respective infrared absorption spectra of the surface-side portion 32, the inner portion 33, and the intermediate portion 34 of the acetylated wood 30, peaks (peak tops) of absorbance are located at positions of 1740 cm⁻¹ and 1510 cm⁻¹. The peak height ratio is a value (ratio value) obtained by dividing a peak height at 1740 cm⁻¹ by a peak height at 1510 cm⁻¹. 1740 cm⁻¹ is a wavenumber of infrared rays absorbed by an acetyl group of the acetylated wood. The absorbance at 1740 cm⁻¹ increases as acetylation of the wood progresses, and therefore becomes higher as the degree of acetylation of the wood becomes higher. However, the infrared rays of 1740 cm⁻¹ are also absorbed by components of the wood. The absorbance at 1510 cm⁻¹ is the wavenumber of the infrared rays absorbed by the components of the wood. The absorbance at 1510 cm⁻¹ is measured without being affected by the acetylation reaction of the wood and without being affected by the acetyl groups of the acetylated wood.

The absorbance of an infrared absorption spectrum varies depending on a measurement environment, even when measured with exactly the same sample. Therefore, as a reference for comparing the degree of acetylation, using the absorbance at 1510 cm⁻¹, the ratio (peak height ratio) of the peak height of the absorbance at 1740 cm⁻¹ to that at 1510 cm⁻¹ is calculated. Based on the peak height ratio, the degree of acetylation is determined, and the surface-side portion 32, the inner portion 33, and the intermediate portion 34 of the acetylated wood 30 are identified. The degree of acetylation is the degree of progress of acetylation of wood. As the peak height ratio increases, the degree of acetylation increases, indicating that acetylation is progressing.

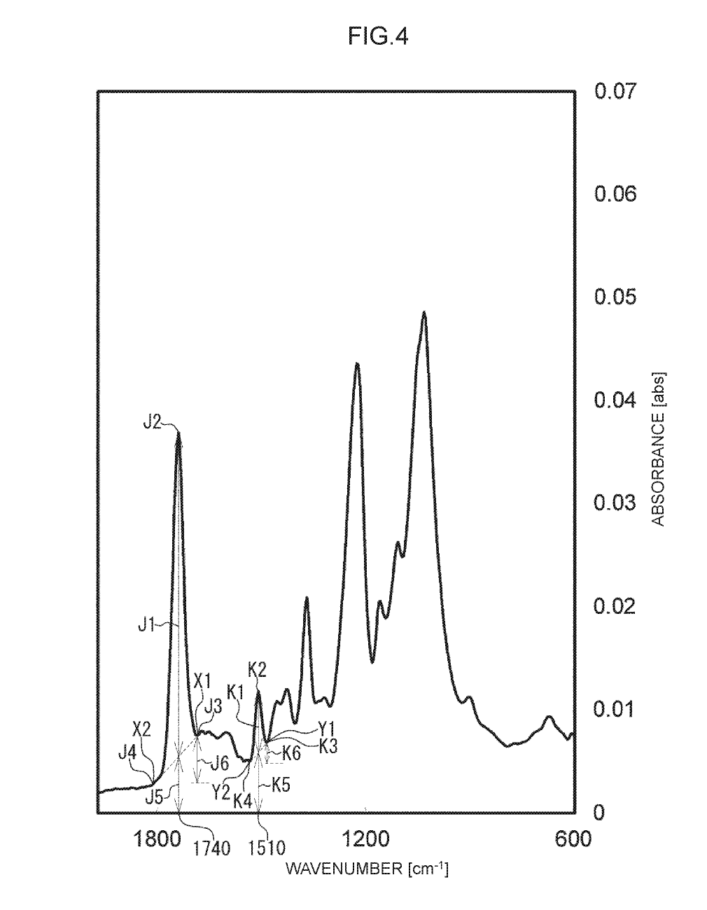

FIG. 4 is a graph illustrating an example of an infrared absorption spectrum of the acetylated wood 30 of the present embodiment, and illustrates a part of the infrared absorption spectrum. Using the infrared absorption spectrum illustrated in FIG. 4 as an example, measurement of a peak height J1 of the infrared absorption spectrum at 1740 cm⁻¹ and a peak height K1 of the infrared absorption spectrum at 1510 cm⁻¹ will be described. FIG. 4 schematically illustrates a manner of measurement of each peak height J1 and K1.

The peak height J1 of 1740 cm⁻¹ is measured as follows. In the infrared absorption spectrum, an absorbance J2 at 1740 cm⁻¹ is measured. In addition, absorbances J3 and J4 at both ends (both tails) X1 and X2 of the absorption band including the peak of the absorbance J2 at 1740 cm⁻¹ are measured to calculate a baseline absorbance J5 at 1740 cm⁻¹. Among the absorbances J3 and J4 at both ends X1 and X2, a high absorbance is defined as J3, and a low absorbance is defined as J4. The broken line illustrated in FIG. 4 is a straight line connecting both ends X1 and X2 of the absorption band including the peak of the absorbance J2 at 1740 cm⁻¹.

Here, one end X1 is a right end of an absorption band illustrated in FIG. 4, and a wavenumber of the one end X1 is smaller than a wavenumber of the other end X2 and 1740 cm⁻¹. In addition, the other end X2 is a left end of an absorption band illustrated in FIG. 4, and a wavenumber of the other end X2 is larger than a wavenumber of the one end X1 and 1740 cm⁻¹. Among the absorbances J3 and J4 at both ends X1 and X2, the absorbance J3 at one end X1 is higher than the absorbance J4 at the other end X2. In this case, an absorbance difference J6, which is the difference between the absorbances J3 and J4 at both ends X1 and X2, is calculated by subtracting the low absorbance J4 from the high absorbance J3 of the absorbances J3 and J4 at both ends X1 and X2 (J6=J3-J4).

The baseline absorbance J5 at 1740 cm⁻¹ is a value obtained by subtracting a value (J6/2) obtained by dividing an absorbance difference J6 by 2 from a higher absorbance J3 (J5=J3−(J6/2)). In addition, the difference between the absorbance J2 of the infrared absorption spectrum at 1740 cm⁻¹ and the baseline absorbance J5 is a peak height J1 of 1740 cm⁻¹. Therefore, the peak height J1 at 1740 cm⁻¹ is a value obtained by subtracting the baseline absorbance J5 at 1740 cm⁻¹ from the absorbance J2 of the infrared absorption spectrum measured at 1740 cm⁻¹ (J1=J2-J5).

The peak height K1 of 1510 cm⁻¹ is measured as follows. In the infrared absorption spectrum, an absorbance K2 at 1510 cm⁻¹ is measured. In addition, absorbances K3 and K4 at both ends (both tails) Y1 and Y2 of the absorption band including the peak of the absorbance K2 at 1510 cm⁻¹ are measured to calculate a baseline absorbance K5 at 1510 cm⁻¹. Among the absorbances K3 and K4 at both ends Y1 and Y2, a high absorbance is defined as K3, and a low absorbance is defined as K4. The broken line illustrated in FIG. 4 is a straight line connecting both ends Y1 and Y2 of the absorption band including the peak of the absorbance K2 at 1510 cm⁻¹.

Here, one end Y1 is a right end of an absorption band illustrated in FIG. 4, and a wavenumber of the one end Y1 is smaller than a wavenumber of the other end Y2 and 1510 cm⁻¹. In addition, the other end Y2 is a left end of an absorption band illustrated in FIG. 4, and a wavenumber of the other end Y2 is larger than a wavenumber of the one end Y1 and 1510 cm⁻¹. Among the absorbances K3 and K4 at both ends Y1 and Y2, the absorbance K3 at one end Y1 is higher than the absorbance K4 at the other end Y2. In this case, an absorbance difference K6, which is the difference between the absorbances K3 and K4 at both ends Y1 and Y2, is calculated by subtracting the low absorbance K4 from the high absorbance K3 of the absorbances K3 and K4 at both ends Y1 and Y2 (K6=K3−K4).

The baseline absorbance K5 at 1510 cm⁻¹ is a value obtained by subtracting a value (K6/2) obtained by dividing an absorbance difference K6 by 2 from a higher absorbance K3 (K5=K3−(K6/2)). In addition, the difference between the absorbance K2 of the infrared absorption spectrum at 1510 cm⁻¹ and the baseline absorbance K5 is a peak height K1 of 1510 cm⁻¹. Therefore, the peak height K1 at 1510 cm⁻¹ is a value obtained by subtracting the baseline absorbance K5 at 1510 cm⁻¹ from the absorbance K2 of the infrared absorption spectrum measured at 1510 cm⁻¹ (K1=K2-K5).

In the infrared absorption spectrum measured at the surface-side portion 32 of the acetylated wood 30, the peak height J1 at 1740 cm⁻¹ is A, and the peak height K1 at 1510 cm⁻¹ is B. In this case, the peak height ratio A/B of a peak height A at 1740 cm⁻¹ to a peak height B at 1510 cm⁻¹ in an infrared absorption spectrum of the surface-side portion 32 is 2 or more (A/B≥2). In addition, the maximum value of the peak height ratio A/B in the infrared absorption spectrum measured at the surface-side portion 32 is 6. Therefore, the peak height ratio A/B is 2 or more and 6 or less (2≤A/B≤6).

In the infrared absorption spectrum measured at the inner portion 33 of the acetylated wood 30, the peak height J1 at 1740 cm⁻¹ is defined as C, and the peak height K1 at 1510 cm⁻¹ is defined as D. In this case, the peak height ratio C/D of a peak height C at 1740 cm⁻¹ to a peak height D at 1510 cm⁻¹ in an infrared absorption spectrum of the inner portion 33 is 0.5 or less (C/D≤0.5). In addition, the minimum value of the peak height ratio C/D in the infrared absorption spectrum measured at the inner portion 33 is 0.2. Therefore, the peak height ratio C/D is 0.2 or more and 0.5 or less (0.2≤C/D≤0.5). The peak height ratio C/D varies depending on the state of the inner portion 33 or the like.

The intermediate portion 34 of the acetylated wood 30 is a portion between the surface-side portion 32 and the inner portion 33, and has a lower degree of acetylation than the surface-side portion 32. In addition, in the intermediate portion 34, the degree of acetylation gradually decreases from the surface-side portion 32 toward the inner portion 33. In the infrared absorption spectrum measured at the intermediate portion 34, the peak height J1 at 1740 cm⁻¹ is defined as E, and the peak height K1 at 1510 cm⁻¹ is defined as F. In this case, a peak height ratio E/F of a peak height E at 1740 cm⁻¹ and a peak height F at 1510 cm⁻¹ in an infrared absorption spectrum of the intermediate portion 34 is smaller than the peak height ratio A/B of the surface-side portion 32 and greater than a peak height ratio C/D of the inner portion 33 (C/D<E/F<A/B). The peak height ratio E/F of the intermediate portion 34 is a value between the peak height ratio A/B of the surface-side portion 32 and the peak height ratio C/D of the inner portion 33, and gradually decreases from the surface-side portion 32 toward the inner portion 33.

In a case where the peak height ratio A/B of the surface-side portion 32 of the acetylated wood 30 is less than 2 (A/B<2), acetylation of the surface-side portion 32 may be insufficient. In contrast, in a case where the peak height ratio A/B of the surface-side portion 32 is 2 or more, a degree of acetylation in the surface-side portion 32 is increased, and durability associated with acetylation can be reliably exhibited by the surface-side portion 32 including the wood surface 31. Furthermore, the inner portion 33 is provided inside the surface-side portion 32. Therefore, as compared with wood uniformly acetylated as a whole, it is possible to reduce an amount of a chemical agent for acetylation used during acetylation treatment, and it is also possible to shorten a time required for the acetylation treatment. Accordingly, it is possible to provide the acetylated wood 30 capable of reducing the manufacturing cost while ensuring durability.

In a case where the peak height ratio is greater than 0.5, although a degree of acetylation is low, the amount of a chemical agent for acetylation used during acetylation treatment may be affected. In contrast, the peak height ratio C/D of the inner portion 33 of the acetylated wood 30 is 0.5 or less. Therefore, it is possible to reliably reduce an amount of a chemical agent for acetylation used during acetylation treatment.

By the incising process, during acetylation treatment, penetration of a chemical agent into the wood 20 before acetylation can be promoted, and a time required for penetration of the chemical agent into the wood 20 can be shortened. Therefore, it is possible to shorten a time required for acetylation of the surface-side portion 32 of the acetylated wood 30 and to reduce a manufacturing cost of the acetylated wood 30. Furthermore, by performing the incising process only on the surface-side portion 32, it is possible to efficiently acetylate the surface-side portion 32 while suppressing acetylation of portions located inside the surface-side portion 32 of the acetylated wood 30 (included portion 35, intermediate portion 34, and inner portion 33).

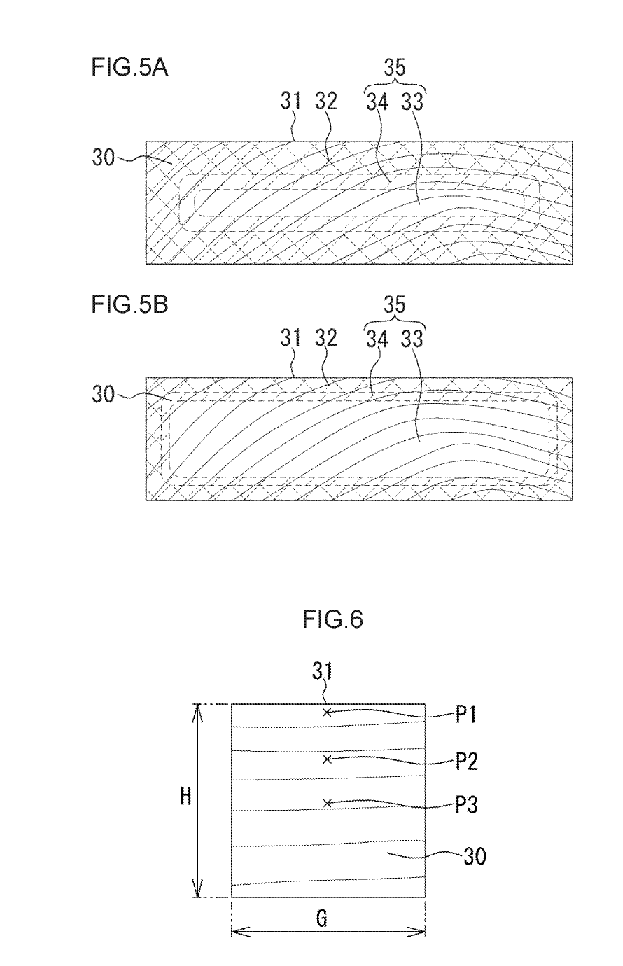

FIG. 5A and FIG. 5B are cross-sectional views illustrating other examples of the acetylated wood 30 of the present embodiment, and illustrate two acetylated woods 30.

As illustrated in the drawing, the acetylated wood 30 is a plate material and is formed in a rectangular cross-sectional shape. In addition, in the acetylated wood 30 illustrated in FIG. 5A and the acetylated wood 30 illustrated in FIG. 5B, the thicknesses, ranges, and boundary positions of the surface-side portion 32, the inner portion 33, and the intermediate portion 34 are different from each other.

As described above, the disclosure is applicable to the acetylated woods 30 of various shapes. Therefore, the acetylated wood 30 is not particularly limited in shape, and can be implemented as woods of various shapes (for example, a plate material, a square timber, and a column material). Furthermore, in the acetylated wood 30, thicknesses, ranges, and boundary positions of the surface-side portion 32, the inner portion 33, and the intermediate portion 34 vary depending on a shape of the acetylated wood 30, a state of the acetylated wood 30, conditions of acetylation treatment, and the like.

### Examples

The acetylated wood 30 was manufactured by a manufacturing procedure of the acetylated wood 30 illustrated in FIG. 2. Furthermore, the infrared absorption spectrum of the acetylated wood 30 was measured by the Fourier transform infrared spectrophotometer.

FIG. 6 is a cross-sectional view illustrating the acetylated wood 30 of examples. In FIG. 6, the description of the configuration of the acetylated wood 30 is omitted, and a cross section of the acetylated wood 30 is illustrated.

As illustrated, the acetylated wood 30 is a square timber, and dimensions G and H of the acetylated wood 30 are both 30 mm.

Infrared absorption spectra were measured at three measurement positions P1, P2, and P3 (a first measurement position P1, a second measurement position P2, and a third measurement position P3) having different distances from the wood surface 31 of the acetylated wood 30. The first measurement position P1 is closest to the wood surface 31 among the three measurement positions P1, P2, and P3. The third measurement position P3 is the farthest from the wood surface 31 among the three measurement positions P1, P2, and P3, and is located near the center of the acetylated wood 30. The second measurement position P2 is a position between the first measurement position P1 and the third measurement position P3.

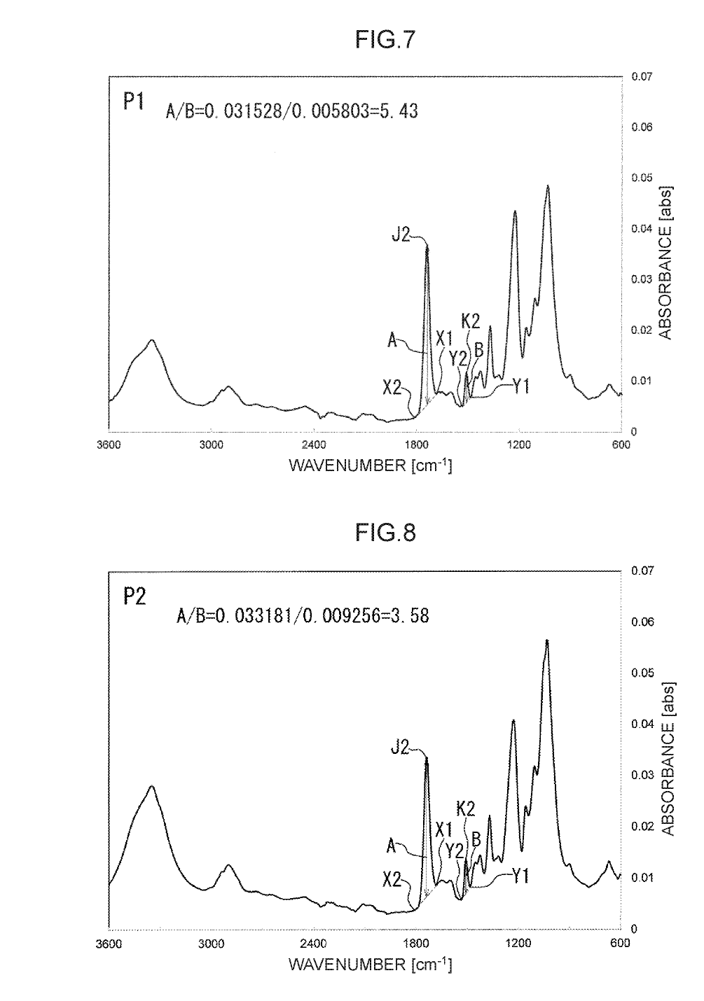

FIGS. 7, 8, and 9 are graphs illustrating an infrared absorption spectrum of the acetylated wood 30. The broken lines illustrated in FIGS. 7, 8, and 9 are straight lines connecting both ends X1 and X2 of the absorption band including the peak of absorbance J2 at 1740 cm⁻¹, and straight lines connecting both ends Y1 and Y2 of the absorption band including the absorbance peak K2 at 1510 cm⁻¹. In the infrared absorption spectra of FIGS. 7, 8, and FIG. 9, only J2, K2, X1, X2, Y1, and Y2 among the reference numerals shown in the infrared absorption spectrum of FIG. 4 are given, and descriptions of other reference numerals are omitted.

As illustrated, the infrared absorption spectra at the three measurement positions P1, P2, and P3 are different from each other. Furthermore, the absorbance peaks of the three infrared absorption spectra are located at positions of 1740 cm⁻¹ and 1510 cm⁻¹.

In the infrared absorption spectrum at the first measurement position P1 (see FIG. 7), the absorbance J2 of the infrared absorption spectrum at 1740 cm⁻¹ is 0.0368. Absorbances J3 and J4 at both ends X1 and X2 of the absorption band including the peak of the absorbance J2 at 1740 cm⁻¹ are 0.008062and 0.002482, respectively. Thus, the baseline absorbance J5 at 1740 cm⁻¹ is 0.005272. The peak height A at 1740 cm⁻¹ is 0.031528 calculated by subtracting the baseline absorbance J5 from the absorbance J2 of the infrared absorption spectrum at 1740 cm⁻¹ (0.0368-0.005272).

The absorbance K2 of the infrared absorption spectrum at 1510 cm⁻¹ is0.0117. Absorbances K3 and K4 at both ends Y1 and Y2 of the absorption band including the peak of the absorbance K2 at 1510 cm⁻¹ are 0.006799and0.004994, respectively. Thus, the baseline absorbance K5 at 1510 cm⁻¹ is 0.005897. The peak height B at 1510 cm⁻¹ is 0.005803 calculated by subtracting the baseline absorbance K5 from the absorbance K2 of the infrared absorption spectrum at 1510 cm⁻¹ (0.0117-0.005897). Therefore, the peak height ratio A/B is 5.43 (=0.031528/0.005803). Since the peak height ratio A/B is 2 or more, the first measurement position P1 of the acetylated wood 30 is at the surface-side portion 32.

In the infrared absorption spectrum at the second measurement position P2 (see FIG. 8), the absorbance J2 of the infrared absorption spectrum at 1740 cm⁻¹ is 0.0400. Absorbances J3 and J4 at both ends X1 and X2 of the absorption band including the peak of the absorbance J2 at 1740 cm⁻¹ are 0.009935 and 0.003702, respectively. Thus, the baseline absorbance J5 at 1740 cm⁻¹ is 0.006819. The peak height A at 1740 cm⁻¹ is 0.033181 calculated by subtracting the baseline absorbance J5 from the absorbance J2 of the infrared absorption spectrum at 1740 cm⁻¹ (0.0400-0.006819).

The absorbance K2 of the infrared absorption spectrum at 1510 cm⁻¹ is 0.0160. Absorbances K3 and K4 at both ends Y1 and Y2 of the absorption band including the peak of the absorbance K2 at 1510 cm⁻¹ are 0.008014 and 0.005474, respectively. Thus, the baseline absorbance K5 at 1510 cm⁻¹ is 0.006744. The peak height B at 1510 cm⁻¹ is 0.009256 calculated by subtracting the baseline absorbance K5 from the absorbance K2 of the infrared absorption spectrum at 1510 cm⁻¹ (0.0160-0.006744). Therefore, the peak height ratio A/B is 3.58 (=0.033181/0.009256). Since the peak height ratio A/B is 2 or more, the second measurement position P2 of the acetylated wood 30 is at the surface-side portion 32.

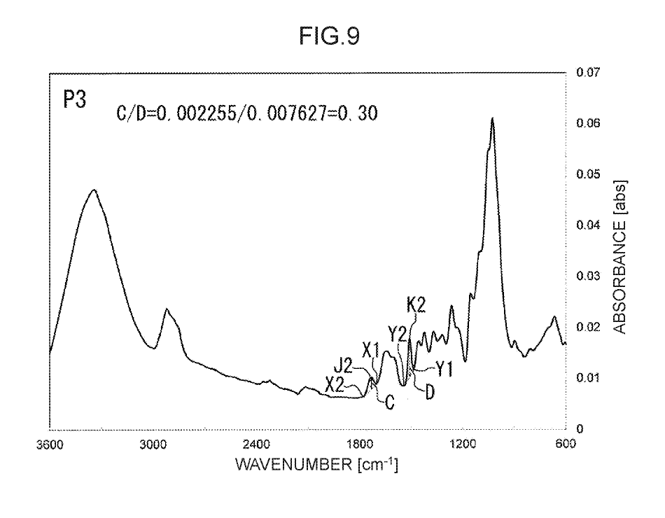

In the infrared absorption spectrum at the third measurement position P3 (see FIG. 9), the absorbance J2 of the infrared absorption spectrum at 1740 cm⁻¹ is 0.0101. Absorbances J3 and J4 at both ends X1 and X2 of the absorption band including the peak of the absorbance J2 at 1740 cm⁻¹ are 0.009228 and 0.006461, respectively. Thus, the baseline absorbance J5 at 1740 cm⁻¹ is 0.007845. The peak height C at 1740 cm⁻¹ is 0.002255 calculated by subtracting the baseline absorbance J5 from the absorbance J2 of the infrared absorption spectrum at 1740 cm⁻¹ (0.0101-0.007845).

The absorbance K2 of the infrared absorption spectrum at 1510 cm⁻¹ is 0.0178. Absorbances K3 and K4 at both ends Y1 and Y2 of the absorption band including the peak of the absorbance K2 at 1510 cm⁻¹ are 0.01177 and 0.008575, respectively. Thus, the baseline absorbance K5 at 1510 cm⁻¹ is 0.010173. The peak height D at 1510 cm⁻¹ is 0.007627 calculated by subtracting the baseline absorbance K5 from the absorbance K2 of the infrared absorption spectrum at 1510 cm⁻¹ (0.0178-0.010173). Therefore, the peak height ratio C/D is 0.30 (=0.002255/0.007627). Since the peak height ratio C/D is 0.5 or less, the third measurement position P3 of the acetylated wood 30 is at the inner portion 33.

As described above, based on infrared absorption spectra measured at three measurement positions P1, P2, and P3 of the acetylated wood 30, the surface-side portion 32 and the inner portion 33 of the acetylated wood 30 are identified. The intermediate portion 34 of the acetylated wood 30 is located between the second measurement position P2 and the third measurement position P3.

As described above, in the present embodiment, acetylated woods described in the following (1) to (3) are disclosed.

(1) An acetylated wood including a surface-side portion that includes a wood surface and is acetylated, and an inner portion located inside the surface-side portion, in which a peak height ratio A/B of a peak height A at 1740 cm⁻¹ to a peak height B at 1510 cm⁻¹ in an infrared absorption spectrum of the surface-side portion is 2 or more, and a peak height ratio C/D of a peak height C at 1740 cm⁻¹ to a peak height D at 1510 cm⁻¹ in an infrared absorption spectrum of the inner portion is 0.5 or less.

In the acetylated wood described in (1), it is possible to provide an acetylated wood capable of reducing manufacturing cost while ensuring durability.

(2) The acetylated wood according to (1), in which the acetylated wood is subjected to an incising process.

In the acetylated wood described in (2), by the incising process, it is possible to shorten a time required for acetylation of a surface-side portion of the acetylated wood and to reduce a manufacturing cost of the acetylated wood.

(3) The acetylated wood according to (2), in which the incising process is applied only to the surface-side portion.

In the acetylated wood described in (3), it is possible to efficiently acetylate a surface-side portion of the acetylated wood while suppressing acetylation of a portion located inside the surface-side portion of the acetylated wood.

According to the disclosure, it is possible to provide an acetylated wood capable of reducing the manufacturing cost while ensuring durability.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An acetylated wood comprising:
a surface-side portion that includes a wood surface and is acetylated; and
an inner portion located inside the surface-side portion, wherein
a peak height ratio A/B of a peak height A at 1740 cm⁻¹ to a peak height B at 1510 cm⁻¹ in an infrared absorption spectrum of the surface-side portion is 2 or more, and
a peak height ratio C/D of a peak height C at 1740 cm⁻¹ to a peak height D at 1510 cm⁻¹ in an infrared absorption spectrum of the inner portion is 0.5 or less.

2. The acetylated wood according to claim 1, wherein
the acetylated wood is subjected to an incising process.

3. The acetylated wood according to claim 2, wherein
the incising process is applied only to the surface-side portion.
